(19) United States
(12) Patent Application Publication
(10) Pub. No.: US 2007/0231543 A1
(43) Pub. Date: Oct. 4, 2007

(54) RELEASE SHEET

(75) Inventors: Takuo Nishida, Saitama (JP); Sou Miyata, Chiba (JP); Toshio Sugisaki, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: LINTEC CORPORATION, Itabashi-ku (JP)

(21) Appl. No.: 11/683,639

(22) Filed: Mar. 8, 2007

(30) Foreign Application Priority Data
Mar. 30, 2006 (JP) 2006-093699

(51) Int. Cl. B32B 5/00

(52) U.S. Cl. 428/141

(57) ABSTRACT

Provided is a release sheet which is a non-silicone based and has a good releasing performance from a pressure sensitive adhesive layer and which is excellent in an aging stability of releasing performance.

The above release sheet comprises a rubber base release agent layer provided on a substrate directly or via an undercoat layer, wherein a central line average roughness (Ra) of a substrate surface or an undercoat layer surface which is brought into contact with the rubber base release agent layer is 0.06 μm or less, and the rubber base release agent layer has a thickness of 0.01 to 5 μm.

### BACKGROUND OF THE INVENTION

1. Field of the Invention

The present invention relates to a release sheet. More specifically, it relates to a release sheet which is a non-silicone based and has a good releasing performance from a pressure sensitive adhesive layer and which is excellent in an aging stability of releasing performance and suited to applications related to precision electronic devices.

2. Description of the Related Art

In recent years, a pressure sensitive adhesive sheet is used in various forms at various stages of production steps for precision electronic devices such as ceramic capacitors, hard disc drives, semiconductor equipments and the like.

In a pressure sensitive adhesive sheet used at such production steps for precision electronic devices, a silicone based pressure sensitive adhesive is likely to cause troubles in electronic parts due to low molecular silicone compounds contained in the above pressure sensitive adhesive, and therefore non-silicone based pressure sensitive adhesives such as, for example, acryl based pressure sensitive adhesives, polyester based pressure sensitive adhesives, urethane base pressure sensitive adhesives and the like are usually used.

In the above pressure sensitive adhesive sheet, a release sheet comprising a release agent layer provided on a substrate is laminated thereon in order to protect a pressure sensitive adhesive layer until it is used.

In the case of general applications, a silicone based release agent is often used for a release agent layer of a release sheet, and when the silicone based release agent is used for the foregoing applications related to precision electronic devices, the low molecular silicone compounds contained in the above release agent are likely to transfer to the pressure sensitive adhesive layer and remain therein to bring about troubles in the electronic devices as is the case with the silicone based pressure sensitive adhesive described above.

Accordingly, alkyd base resins (refer to, for example, a patent document 1), long-chain alkyl base resins (refer to, for example, a patent document 2) and rubber base resins which are non-silicone based release agents are tried to use for a release agent layer of a release sheet used for the applications described above.

However, when the alkyd base resins and the long chain alkyl base resins are used for a release agent layer, brought about is the problem that, the pressure sensitive adhesive layer is not released from the release agent layer in a certain case because of a high releasing strength required for releasing from a pressure sensitive adhesive layer.

Also, when a rubber base resin is used, a release sheet having a good releasing performance from a pressure sensitive adhesive layer is obtained, but involved therein is the problem that a releasing strength from a pressure sensitive adhesive layer grows higher after heat acceleration to make releasing heavier, and there has been the problem that a pressure sensitive adhesive sheet prepared by using the above release sheet is not suited to long storage at high temperature.

### Patent document 1: Japanese Patent Application Laid-Open No. 49685/1982

### Patent document 2: Japanese Patent Application Laid-Open No. 249757/2002

### SUMMARY OF THE INVENTION

In light of the situation described above, an object of the present invention is to provide a release sheet which is a non-silicone based and has a good releasing performance from a pressure sensitive adhesive layer and which is excellent in an aging stability of releasing performance.

Intensive researches repeated by the present inventors in order to achieve the object described above have resulted in finding that the above object can be achieved by a release sheet in which a rubber base resin is used for a release agent layer, wherein controlling a surface roughness (Ra) of a face brought into contact with the release agent layer, that is, a substrate when the release agent layer is formed directly on the substrate and an undercoat layer when the release agent layer is formed directly thereon via the undercoat layer. The present invention has been completed based on the above knowledge.

That is, the present invention provides:

(1) A release sheet comprising a rubber base release agent layer provided on a substrate directly or via an undercoat layer, wherein a central line average roughness (Ra) of a substrate surface or an undercoat layer surface which is brought into contact with the rubber base release agent layer is 0.06 μm or less, and the rubber base release agent layer has a thickness of 0.01 to 5 μm,

### (2) The release sheet as claimed in the above item (1), wherein the rubber base release agent layer is a layer cured by irradiating with an active energy beam,

### (3) The release sheet as claimed in the above item (2), wherein the active energy beam is a UV ray,

### (4) The release sheet as claimed in any one of the above items (1) to (3), wherein the rubber base release agent layer is a layer comprising polybutadiene or polyisoprene,

### (5) The release sheet as claimed in any one of the above items (1) to (4) comprising the rubber base release agent layer provided via the undercoat layer, wherein the above undercoat layer is a layer comprising an alkyd resin or a urethane resin,

### (6) The release sheet as claimed in any one of the above items (1) to (5) comprising the rubber base release agent layer provided via the undercoat layer, wherein the above undercoat layer has a thickness of 0.05 μm or more.

The present invention can provide a release sheet which is a non-silicone based and has a good releasing performance from a pressure sensitive adhesive layer and which is excellent in an aging stability of releasing performance.

### BEST MODE FOR CARRYING OUT THE INVENTION

In the release sheet of the present invention, a central line average roughness (Ra) of a face brought into contact with the release agent layer has to be 0.06 μm or less. That is, the surface of the substrate when the release agent layer is formed directly on the substrate or the surface of the undercoat layer when the release agent layer is formed thereon via the undercoat layer have to have the above central line average roughness (Ra) of the surfaces.

The substrate in the release sheet of the present invention shall not specifically be restricted, and a substrate suitably selected from publicly known substrates which have so far been known as substrates for a release sheet can be used. The above substrate includes, for example, paper substrates such as glassine paper, coated paper, cast-coated paper, lint-free paper and the like, laminated papers prepared by laminating thermoplastic resins such as polyethylene and the like on the above paper substrates, polyester films of polyethylene terephthalate, polybutylene terephthalate, polyethylene naphthalate and the like, polyolefin films of polypropylene, polymethylpentene and the like, plastic films such as a polycarbonate film, a cellulose acetate base film and the like and laminated films comprising the above materials.

When the release sheet comprises the release agent layer provided directly on the substrate, the substrate in which a central line average roughness (Ra) on a surface is 0.06 μm or less has to be selected, and substrates of a smooth or a highly smooth grade can be given as the examples of the above substrate.

A thickness of the above substrate shall not specifically be restricted, and usually it is preferably 10 to 150 μm.

A release sheet comprising a release agent layer provided via an undercoat layer is included in the release sheet of the present invention. The undercoat layer is usually provided in order to improve an adhesion between the substrate and the release agent layer and in order to provide the release sheet with specific characteristics. In the case of the release sheet of the present invention, it is provided mainly in order to smoothen a face brought into contact with the release agent layer. That is, when a substrate in which a central line average roughness (Ra) on a surface exceeds 0.06 μm is used, an undercoat layer having a central line average roughness (Ra) of 0.06 μm or less on a surface is provided.

As a matter of course, also when the substrate in which a central line average roughness (Ra) on a surface is 0.06 μm or less is used, the undercoat layer may be provided as well in order to improve an adhesion between the substrate and the release agent layer and in order to provide the release sheet with specific characteristics. Also in such case, the undercoat layer has to have a central line average roughness (Ra) of 0.06 μm or less on a surface.

Materials suitably selected from those which have so far been used for forming an undercoat layer can be used as a material for forming the undercoat layer as long as they satisfy the conditions that they have a good solvent resistance (insoluble) against a solvent used for a coating liquid (hereinafter referred to as a release agent liquid) for providing the release agent layer and provide the above release agent liquid with a good coating property and that they can form a smooth surface. Alkyd resins, urethane resins, synthetic rubbers, polyethylene resins, polyester resins and the like can be given as the examples of the above materials, and the alkyd resins and the urethane resins are particularly preferred since they have a solvent resistance against a solvent used for the above release agent liquid.

Capable of being given as the alkyd resins are resins in which condensation products of polybasic acids such as phthalic anhydride and the like as an acid component with polyhydric alcohols such as glycerin, ethylene glycol and the like as a glycol component are skeletons and which are obtained by modifying them with fatty acids such as drying oils and the like. Castor oil, soybean oil and flaxseed oil can be given as the above fatty acids.

Capable of being given as the urethane resins are constitutions comprising long-chain polyols such as polyesterpolyols, polyetherpolyols and the like, diisocyanates such as TDI (tolylenediisocyanate), MDI (diphenylmethanediisocyanate), HDI (hexamethylenediisocyanate) and the like and compounds comprising chain elongation agents such as low molecular polyhydric alcohols, aromatic diamines and the like.

The undercoat layer can be formed by coating and drying a coating liquid (hereinafter referred to as a undercoat agent liquid) for providing the undercoat layer. Further, it is cured by irradiating, if necessary, with an active energy beam after coated and dried, whereby the solvent resistance and the adhesion to the substrate can be enhanced.

The undercoat agent liquid in using an alkyd resin is prepared by dissolving the alkyd resin described above, a melamine resin such as methylated melamine and butylated ureamelamine and an acid catalyst such as p-toluenesulfonic acid, methanesulfonic acid, sulfuric acid, hydrochloric acid, formic acid, acetic acid and the like in a solvent.

The undercoat agent liquid in using a urethane resin may be added after prepared by dissolving the urethane resin described above and an isocyanate compound such as TDI (tolylenediisocyanate) and MDI (diphenylmethanediisocyanate) in a solvent.

In the case of either of the undercoat agent liquids, an antioxidant, a photosensitizer and the like can be blended if necessary.

Those suitably selected from publicly known solvents having a good solubility to the blended components can be used as the solvent used for the undercoat agent liquid. The above solvents include, for example, organic solvents such as toluene, xylene, methanol, ethanol, isobutanol, n-butanol, acetone, methyl ethyl ketone, tetrahydrofuran, cyclohexane, heptane and the like and water. They may be used alone or in combination of two or more kinds thereof.

The undercoat agent liquid is preferably prepared using the above solvents in terms of convenience in coating so that a solid matter concentration falls in a range of 0.1 to 15 mass %.

The undercoat agent liquid can be coated on the substrate described above by coating methods which have so far been publicly known, for example, a bar coating method, a reverse roll coating method, a knife coating method, a roll knife coating method, a gravure coating method, an air doctor coating method and a doctor blade coating method.

The undercoat agent liquid is coated on the substrate described above and dried by heating at a temperature of 40 to 160° C. for a time of 30 seconds to 2 minutes and, if necessary, curing by irradiating with an active energy beam, whereby an undercoat layer is formed.

A thickness of the undercoat layer is varied depending on whether the undercoat layer is provided in order to improve an adhesion between the substrate and the release agent layer and in order to provide the release sheet with specific characteristics or whether it is provided in order to smoothen a face brought into contact with the release agent layer. In the latter case, the thickness is, though varied depending on a central line average roughness (Ra) on a substrate surface, preferably 0.05 μm or more, particularly preferably 0.1 to 2 μm in order to improve the adhesion and obtain the smooth surface without being affected by a surface roughness of the substrate surface.

The release agent layer in the release sheet of the present invention is a layer comprising a rubber base release agent of a non-silicone base such as polybutadiene, polyisoprene and a styrene-butadiene copolymer, and a layer cured by irradiating a layer formed by coating a release agent liquid containing polybutadiene or polyisoprene with an active energy beam is particularly preferred for improving the releasing performance from the release agent layer.

The active energy beam used includes an electron beam, a UV ray and the like, and a UV ray is preferred in terms of less damage (deterioration) given to the substrate.

A high pressure mercury lamp, a metal halide lamp, a high power metal halide lamp, an electrodeless lamp and the like which have so far been publicly known can be used as a UV ray lamp used for irradiating with a UV ray, and the electrodeless lamp is most suited in terms of a curing property of polybutadiene or polyisoprene.

A dose of a UV ray is preferably 30 mJ/cm² or more from the viewpoints of curing the release agent layer and improving the releasing performance from the release agent layer, and it is preferably 300 mJ/cm² or less from the viewpoint of capable of avoiding oxidative deterioration of the release agent layer and changing to heavier releasing thereof.

That is, a dose of a UV ray falls preferably in a range of 30 to 300 mJ/cm², particularly preferably 45 to 255 mJ/cm².

Cross-linking by irradiation with a UV ray can further efficiently be carried out by using a photopolymerization initiator and a photosensitizer added to the release agent liquid.

Capable of being given as the photopolymerization initiator are 2,2-dimethoxy-1,2-diphenylethane-1-one, 1-hydroxycyclohexyl phenyl-ketone, 2-hydroxy-2-methyl-1-phenylpropane-1-one, 1-[4-(2-hydroxyethoxy)phenyl]-2-hydroxy-2-methyl-1-propane-1-one, 2-methyl-1-[4-(methylthio)phenyl]-2-morpholinopropane-1-one, 2-benzyl-2-dimethylamino-1-(4-morpholinophenyl)butanone-1, bis(2,4,6-trimethylbenzoyl)phenylphosphine oxide and oligo[2-hydroxy-2-methyl]-1-[4-(1-methylvinyl)phenyl]propanone.

The photosensitizer includes aromatic ketones such as benzophenone, p,p′-dimethoxybenzophenone, p,p′-dichlorobenzophenone, p,p′-dimethylbenzophenone, acetophenone and acetonaphthone, and they provide good results. In addition thereto, aromatic aldehydes such as terephthalaldehyde and the like and quinone base aromatic compounds such as methylanthraquinone and the like can be used as well.

The release agent liquid is prepared by dissolving, for example, polybutadiene or polyisoprene and components such as the photopolymerization initiator, the photosensitizer and the antioxidant each described above which are blended if necessary in a solvent.

The antioxidant shall not specifically be restricted, and those suitably selected from publicly known phosphite base antioxidants, organic sulfur base antioxidants, hindered phenol base antioxidants and the like can be used.

Those suitably selected from publicly known solvents having a good solubility to the blend components can be used as the solvent used for the release agent liquid. The same ones as in the case of the undercoat agent liquid described above can be given as the examples of the above solvents.

The release agent liquid is preferably prepared using the above solvents so that a solid matter concentration falls in a range of 0.1 to 15 mass % in terms of convenience in coating.

The release agent liquid can be coated on the substrate or the undercoat layer by coating methods which have so far been publicly known as is the case with the undercoat agent described above.

A thickness of the release agent layer thus formed is preferably 0.01 μm or more in order to stabilize a coating property and obtain an even coating film so that it is not affected by irregularities on the surface of the substrate or the undercoat layer, and it is preferably 5 μm or less in order that the release agent layer is not reduced in an adhesion to the substrate or the undercoat layer and a curing property and that a low releasing strength is obtain. That is, the thickness falls in a range of preferably 0.01 to 5 μm, particularly preferably 0.03 to 2 μm.

If a thickness of the release agent layer falls in the above range, a central line average roughness (Ra) of the release agent layer follows a central line average roughness (Ra) of a substrate surface or a undercoat layer surface, and the same central line average roughness (Ra) as that of the substrate surface or the undercoat layer surface is obtained. Accordingly, the smooth release agent layer surface is obtained.

The pressure sensitive adhesive applied to the release sheet of the present invention shall not specifically be restricted, and it can suitably be selected from pressure sensitive adhesives which have so far been publicly known, such as acryl base pressure sensitive adhesives, polyester base pressure sensitive adhesives, urethane base pressure sensitive adhesives and the like.

The substrate surface or the undercoat layer surface in the release sheet of the present invention has a central line average roughness (Ra) of 0.06 μm or less, and the release agent layer has a thickness falling in a range of 0.01 to 5 μm. When the above condition is satisfied, a central line average roughness (Ra) of the release agent layer surface follows a central line average roughness (Ra) of the substrate surface or the undercoat layer surface, and the same central line average roughness (Ra) as that of the substrate surface or the undercoat layer surface is obtained. Accordingly, the smooth release agent layer surface having a central line average roughness (Ra) of 0.06 μm or less is obtained.

If a pressure sensitive adhesive sheet using a release sheet in which a release agent layer has a central line average roughness (Ra) exceeding 0.06 μm is subjected to heat acceleration, the pressure sensitive adhesive layer is softened, and the pressure sensitive adhesive penetrates into fine irregularities on the release agent layer surface, which leads to bringing about heavy releasing. However, a pressure sensitive adhesive sheet using the release sheet of the present invention has a central line average roughness (Ra) of 0.06 μm or less on a release agent layer surface, and if the pressure sensitive adhesive sheet is subjected to heat acceleration, a pressure sensitive adhesive sheet surface is maintained in a smoothened state. Accordingly, the pressure sensitive adhesive sheet having a good releasing performance is obtained.

### EXAMPLES

Next, the present invention shall be explained in further details with reference to examples, but the present invention shall by no means be restricted by these examples.

Various evaluations of release sheets obtained in the examples and the comparative examples were carried out by the following methods.

### (1) Measurement of Initial Releasing Strength:

An acryl base pressure sensitive adhesive (trade name: PL Sin, manufactured by Lintec Corporation) was coated (coated amount after dried: 24 g/m²) on a release agent layer face of the release sheet which was a test object and stuck with a polyethylene terephthalate film (hereinafter abbreviated as a PET film) (trade name: Lumirror E20 #50, thickness: 50 μm, manufactured by Toray Industries, Inc.), and a roller of 2 kg was reciprocated thereon one time to prepare a pressure sensitive adhesive sheet. The above pressure sensitive adhesive sheet was left standing for a day on the conditions of a temperature of 23° C. and a relative humidity of 50%, and then the releasing strength was measured.

The measurement was carried out by pulling the pressure sensitive adhesive sheet to a 180° direction at a speed of 300 mm/minute under the conditions of a temperature of 23° C. and a relative humidity of 50% based on JIS-Z0237 by means of a universal tensile testing machine (model: TENSILON UTM-4-100, manufactured by ORIENTEC Co., Ltd.).

### (2) Releasing Strength after Heat Acceleration:

The releasing strength was measured in the same manner as in the measurement of the initial releasing strength, except that the pressure sensitive adhesive sheet was left standing for a day under the conditions of a temperature of 70° C. and a drying state after left standing for a day on the conditions of a temperature of 23° C. and a relative humidity of 50%.

If the releasing strength in the initial stage and after heat acceleration exceeds 1000 mN/20 mm, the sheet brings about changing to heavier releasing and can not substantially be used.

### (3) Measurement of Central Line Average Roughnesses (Ra) of Release Sheet Substrate Surface, Undercoat Layer Surface and Release Agent Layer Surface:

The central line average roughnesses (Ra) of the release sheet substrate surface, the undercoat layer surface and the release agent layer surface were measured according to JIS B0601-1994 by means of a contact type surface roughness meter (model: SV3000S4, manufactured by MITUTOYO CORPORATION.).

### Example 1

A hindered phenol base antioxidant (trade name: Irganox HP2251, manufactured by Ciba Specialty Chemicals K. K.) 1 mass part was added to polybutadiene (trade name: Nipol BR1241, solid matter concentration: 5 mass %, manufactured by Zeon Corporation) 100 mass parts, and the mixture was diluted to a solid matter concentration of 0.5 mass % with toluene. This solution was used as a release agent liquid and applied on a PET film having a thickness of 38 μm (trade name: PET 30-T300, Ra: 0.03 μm, manufactured by Mitsubishi Polyester Film Corp.) by means of a Mayer bar #4 so that a film thickness after dried was 0.1 μm, and it was dried at 100° C. for 30 seconds.

Then, the coated layer was irradiated with a UV ray on the condition of a conveyor speed of 40 m/minute (UV ray dose: 100 mJ/cm²) by means of a belt conveyor system UV ray irradiation device equipped with a fusion H valve having one 240 w/cm lamp which was an electrodeless lamp to cure it, whereby a release sheet was obtained.

### Example 2

A release sheet was obtained in the same manner as in Example 1, except that the substrate was changed to a PET film (trade name: PET 38-T700, Ra: 0.01 μm, manufactured by Mitsubishi Polyester Film Corp.)

### Example 3

An undercoat agent liquid prepared by diluting 100 mass parts of polyesterpolyol (trade name: Crisvon 5150S, solid matter concentration: 50 mass %, manufactured by Dainippon Ink & Chemicals Inc.) and 5 mass parts of a tolylenediisocyanate compound (trade name: Crisvon NX, manufactured by Dainippon Ink & Chemicals Inc.) to a solid matter concentration of 1 mass % with methyl ethyl ketone was applied as an undercoat layer on a PET film having a thickness of 38 μm (trade name: PET 38-T100, Ra: 0.08 μm, manufactured by Mitsubishi Polyester Film Corp.) by means of a Mayer bar #4 so that a film thickness after dried was 0.15 μm, and it was dried at 100° C. for one minute to form an undercoat layer (Ra: 0.03 μm) of a urethane resin.

Then, a releasing layer was formed on the above undercoat layer in the same manner as in Example 1 to obtain a release sheet.

### Example 4

A release sheet was obtained in the same manner as in Example 1, except that a solution prepared by dissolving 100 mass parts of a mixture of an alkyd resin and methylated melamine (trade name: Tesfine 303, solid matter concentration: 20 mass %, manufactured by Hitachi Kasei Polymer Co. Ltd.) and 3 mass parts of p-toluenesulfonic acid (trade name: 6192-52-5, manufactured by Aldrich Co. Ltd.) in methyl ethyl ketone and diluting them to a solid matter concentration of 3 mass % was used and applied by means of a Mayer bar #4 so that a film thickness after dried was 0.15 μm and that it was dried at 140° C. for one minute to form an undercoat layer (Ra: 0.05 μm).

### Example 5

A release sheet was obtained in the same manner as in Example 1, except that polyisoprene rubber (trade name: IR2200, manufactured by JSR Corporation) was used in place of 100 mass parts of polybutadiene.

### Example 6

A release sheet was obtained in the same manner as in Example 1, except that a dose of a UV ray was changed to 50 mJ/cm².

### Example 7

A release sheet was obtained in the same manner as in Example 1, except that a dose of a UV ray was changed to 250 mJ/cm².

### Example 8

A release sheet was obtained in the same manner as in Example 1, except that a thickness of the release agent layer was changed to 0.05 μm.

### Example 9

A release sheet was obtained in the same manner as in Example 1, except that a thickness of the release agent layer was changed to 1.00 μm.

### Comparative Example 1

A release sheet was obtained in the same manner as in Example 1, except that the substrate was changed to a PET film having a thickness of 38 μm (trade name: PET 38-T100, Ra: 0.08 μm, manufactured by Mitsubishi Polyester Film Corp.).

### Comparative Example 2

A release sheet was obtained in the same manner as in Example 1, except that a thickness of the release agent layer was changed to 10 μm.

The central line average roughnesses (Ra) of substrate surfaces, undercoat layer surfaces and release agent layer surfaces in the release sheets obtained in Examples 1 to 9 and Comparative Examples 1 and 2 were measured, and the release sheets were evaluated. The results thereof are shown in Table 1.

TABLE 1

| | Central line average | | | | |
|---|---|---|---|---|---|
| | roughness (Ra) (μm) | | | Releasing strength | |
| | | Undercoat | Release | (mN/20 mm) | |
| | Substrate | layer | agent | Initial | After heat |
| | surface | surface | layer surface | stage | acceleration |
| Example 1 | 0.03 | — | 0.03 | 98 | 95 |
| Example 2 | 0.01 | — | 0.01 | 82 | 83 |
| Example 3 | 0.08 | 0.03 | 0.03 | 95 | 100 |
| Example 4 | 0.08 | 0.05 | 0.05 | 108 | 160 |
| Example 5 | 0.03 | — | 0.03 | 100 | 111 |
| Example 6 | 0.03 | — | 0.03 | 97 | 97 |
| Example 7 | 0.03 | — | 0.03 | 93 | 97 |
| Example 8 | 0.03 | — | 0.03 | 110 | 112 |
| Example 9 | 0.03 | — | 0.03 | 90 | 112 |
| Comparative | 0.08 | — | 0.08 | 100 | 1500 |
| Example 1 | | | | | |
| Comparative | 0.03 | | 0.01 | 1200 | 2700 |
| Example 2 | | | | | |

What is claimed is:

1. A release sheet comprising a rubber base release agent layer provided on a substrate directly or via an undercoat layer, wherein a central line average roughness (Ra) of a substrate surface or an undercoat layer surface which is brought into contact with the rubber base release agent layer is 0.06 μm or less, and the rubber base release agent layer has a thickness of 0.01 to 5 μm.

2. The release sheet as claimed in claim 1, wherein the rubber base release agent layer is a layer cured by irradiating with an active energy beam.

3. The release sheet as claimed in claim 2, wherein the active energy beam is a UV ray.

4. The release sheet as claimed in any one of claims 1 to 3, wherein the rubber base release agent layer is a layer comprising polybutadiene or polyisoprene.

5. The release sheet as claimed in any one of claims 1 to 4 comprising the rubber base release agent layer provided via the undercoat layer, wherein the above undercoat layer is a layer comprising an alkyd resin or a urethane resin.

6. The release sheet as claimed in any one of claims 1 to 5 comprising the rubber base release agent layer provided via the undercoat layer, wherein the above undercoat layer has a thickness of 0.05 μm or more.
